(19) United States
(12) Patent Application Publication
(10) Pub. No.: US 2007/0038598 A1
(43) Pub. Date: Feb. 15, 2007

(54) METHOD AND SYSTEM FOR ASYNCHRONOUS DATA QUERY AND STORAGE MEDIA STORING A COMPUTER PROGRAM FOR EXECUTING THE METHOD

(76) Inventor: Wei-Kuo Liang, Taipei Hsien (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 11/163,284

(22) Filed: Oct. 13, 2005

(30) Foreign Application Priority Data
Aug. 11, 2005 (TW) 94127283

(51) Int. Cl. G06F 17/30

(52) U.S. Cl. 707/3

(57) ABSTRACT

A method and a system for asynchronous data query and a storage media storing a computer program for executing the method are provided, which can be used in the network of an enterprise information system or on the web site of an Internet information provider to solve the problem of the delay and the performance bottleneck caused by repeated data queries from many users. The main steps of the method are as follows. First, query a database at certain moments according to a predetermined rule to obtain a query result and use the query result to update a variable of a web server. Then, provide the variable to a user.

### CROSS-REFERENCE TO RELATED APPLICATION

This application claims the priority benefit of Taiwan application serial no. 94127283, filed on Aug. 11, 2005. All disclosure of the Taiwan application is incorporated herein by reference.

### BACKGROUND OF THE INVENTION

1. Field of Invention

The present invention relates to a method and a system for data query which can be used in the network of an enterprise information system or on the web site of an Internet information provider. More particularly, the present invention relates to a method and a system for asynchronous data query.

2. Description of Related Art

In the modern enterprises, report query web pages are usually used for inquiring various information of the enterprises. FIG. 1 is a diagram illustrating the data query process according to the conventional technology. The user may use browser 101 to connect to the report query web page provided by server 103 through network 102. The report query web page will query data from database 104, and then send the result back to the user browser 101 through network 102.

In this kind of web pages, some information, for example, selections in drop down menus, will be queried by all users repeatedly. Along with the expansion of an enterprise, the amount of data will increase constantly, and some repeatedly appeared information will have to be obtained through enormous and complicated database queries. For example, if every location of a large enterprise has millions of data, the entire enterprise may have hundreds of billions of data. Synchronous process is used in conventional data query, that is, the report query web page will only issue a query command to the database when it receives a request from the user, the user can only get the result after the enormous and complicated query command is executed.

Thus, in the process of FIG. 1, there will be bottleneck in the data query between server 103 and database 104. If there are always several users query the same data repeatedly, the bottleneck will become more serious, which will not only add to the burden of the database, but also prolong the users' waiting time considerably.

### SUMMARY OF THE INVENTION

Accordingly, the present invention is directed to provide a method for asynchronous data query to reduce query times and ease the burden of the database.

According to another aspect of the present invention, a computer readable storage media storing the computer program for executing the method of asynchronous data query is provided to reduce the amount of the database usage and accelerate the time for obtaining data.

According to yet another aspect of the present invention, a system for asynchronous data query is provided to ease the burden of the server's memory and shorten the users' waiting time.

To accomplish the aforementioned and other aspects, the present invention provides a method for asynchronous data query including the following steps. First, (a) execute the following two steps at certain moments according to a predetermined rule: (a1) querying the database to obtain a query result; and (a2) updating a variable using the query result. Then (b) provide the aforementioned variable to the user.

In an embodiment of the aforementioned asynchronous data query method, the aforementioned predetermined rule is executing steps (a1) and (a2) according to a predetermined period.

In an embodiment of the aforementioned asynchronous data query method, step (a1) further includes connecting to the database and issuing a structure query language (SQL) command to the database to obtain query result.

In an embodiment of the aforementioned asynchronous data query method, refuse to provide the aforementioned variable if the user's login ID has no right of reading the variable.

In an embodiment of the aforementioned asynchronous data query method further include encrypting at least one of the name and content of the aforementioned variable.

According to another aspect of the present invention, a computer readable storage media is provided for storing a computer program for executing the aforementioned asynchronous data query method.

According to still another aspect of the present invention, an asynchronous data query system including a database, a server, and a query program is provided. Wherein, the server provides a variable to the user. The query program queries the database at certain moments according to a predetermined rule to obtain query result and updates the aforementioned variable using the aforementioned query result.

According to exemplary embodiments of the present invention, the database is queried at certain moments in asynchronous manner to update the variable of the server, then the server can provide the variable instantly to the user when the user queries so that the user's waiting time can be shortened. Since the repeated queries from many users are centralized and simplified as a time query, the number of queries to the database is reduced, the burden of the database is eased and the usage of the server's memory is decreased.

In order to make the aforementioned and other objects, features and advantages of the present invention comprehensible, a preferred embodiment accompanied with figures is described in detail below.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a diagram illustrating the data query method according to the conventional technology.

FIG. 2 is a diagram illustrating the system for asynchronous data query according to an embodiment of the present invention.

FIGS. 3 and 4 illustrate the flowchart of the method for asynchronous data query according to an embodiment of the present invention.

FIG. 5 is a schematic block diagram of the query program in FIG. 2.

### DESCRIPTION OF EMBODIMENTS

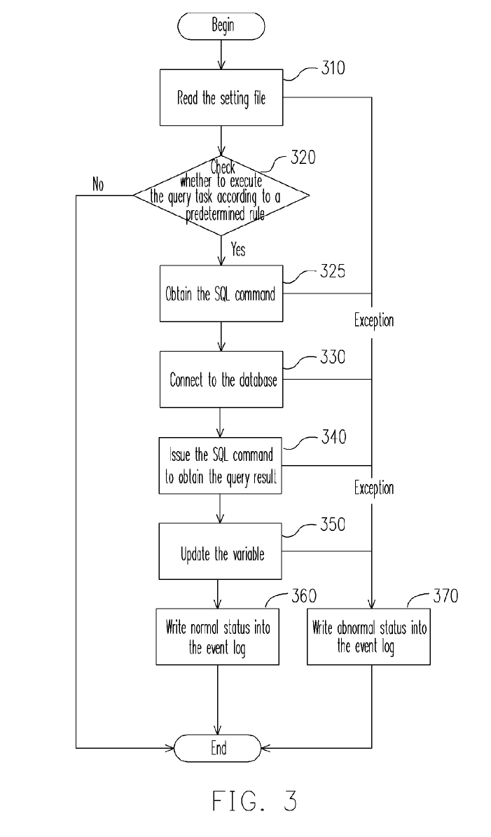

An embodiment of the present invention will be explained below referring to FIGS. 2 to 4. First, FIG. 2 is a diagram illustrating the asynchronous data query system 203 according to the present embodiment of the present invention. Asynchronous data query system 203 includes a server 204, a query program 205 and a database 206.

Wherein, the database 206 is responsible for storing data and responding to the queries. The server 204 is responsible for providing a variable to the user 201 through the network 202. The content of the aforesaid variable is the data queried beforehand which can be used by the user 201 directly, and the details thereof will be described later. In the present embodiment, the server 204 is a personal computer installed with Microsoft Internet Information Service (IIS). The network 202 may be a local area network or the Internet. And the user 201 may be a browser web page or an independent application program.

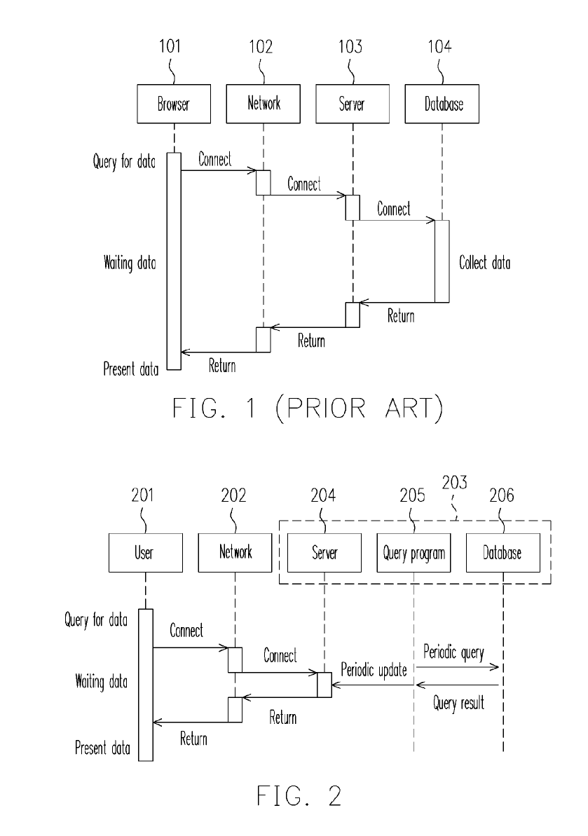

In the present embodiment, the query program 205 is in the server 204 or in another independent computer (not shown in FIG. 2) as a computer readable storage media, for example, stored in the memory, hard disk, or CD. The asynchronous data query according to the present invention is mainly executed by the query program 205. The so-called “asynchronous data query” means that the query from the user 201 to the server 204 and the query from the server 204 to the database 206 are performed independently instead of in a successive order as in FIG. 1. In short, the query program 205 will query the database 206 at certain moments according to a predetermined rule to obtain the query result, and then update the variable of the server 204 using the query result so that users may get the latest data in the server 204. The query of the query program 205 is the query issued repeatedly from the user 201 originally. The query result is stored in the variable of the server 204 so that the user 201 may obtain the result once it is connected to the server 204. Accordingly, the user's waiting time can be dramatically shortened. On the other hand, the burden of the database can be eased considerably because the query program 205 centralizes and simplifies the queries issued repeatedly by many users originally to a time query of a single program.

In the present embodiment, the aforementioned predetermined rule is querying the database 206 according to a predetermined period, for example, querying the database every three or five minutes. Of course, more complicated timing rule may be used. The query program 205 will check every second whether to execute the query task.

In the present embodiment, the query program 205 will issue an SQL command to the database 206 to obtain the query result. As to the query result, it may be a single word, single number, array, data set, data table, data view or extensible markup language (XML).

For the security of data, the query program 205 may encrypt the variable name or the variable content of the server 204 or both when it is updating the variable. When the user 201 is connecting to the server 204, the query program 205 will refuse to provide the variable if the user's login ID has no right of reading the variable. In addition, the query program 205 also includes the function of event log. If the variable is updated successfully, the query program 205 will write normal status into the event log. Otherwise, if exception occurs during the process of querying the database 206 during the updating of the variable, the query program 205 will write abnormal status into the event log.

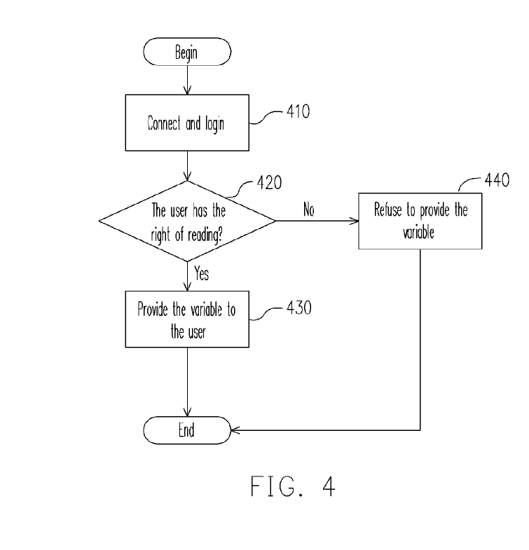

Next, FIGS. 3 and 4 are the detailed flowcharts illustrating the asynchronous data query method executed by the query program 205 according to the present embodiment. FIG. 3 is the flowchart of updating the variable at certain moments.

First, read the setting file in step 310. This setting file includes all information might be used by the query program 205, e.g. predetermined timing rule, whether to execute the timing rule, which database to connect to, ID and password needed for logging into the database, the SQL command to be issued to the database, query result type etc. Certainly, within the scope of the present invention, methods other than setting files may be used to obtain the aforementioned information. For example, all or part of the aforementioned information may be obtained from database on the network, from another computer on the network, or from constants or variables in the program.

After the setting file is read, it goes to step 320 of the flow to check whether to execute the query task according to a predetermined timing rule. If not, the flow ends here. If yes, it will go to step 325 to obtain the SQL command required for query, connect to the database 206 in step 330, then go to step 340, issue the SQL command to the database 206 to obtain the query result. Next, it will go to step 350 of the flow to update the variable using the aforesaid query result. Encrypt the variable name or the variable content or both when updating the variable. Finally, it goes to step 360 to write normal status into the event log. On the other hand, it will go to step 370 to write abnormal status into the event log if any exception occurs during the process of step 310 to step 350.

Next, FIG. 4 is the flow executed by the query program 205 when the user 201 is querying data.

First, in step 410, the user 201 will connect to the server 204 and log into the report query web page. Next, in step 420, the query program 205 will check whether the login ID of the user 201 has the right of reading the variable. If yes, the query program 205 will provide the variable to the user 201 in step 430; otherwise, the query program 205 will refuse to provide the variable in step 440.

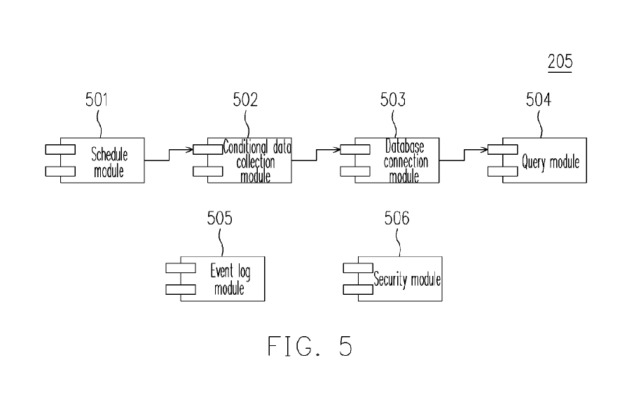

FIG. 5 is a schematic block diagram of the query program 205 according to the present embodiment. The query program 205 includes six modules: schedule module 501, conditional data collection module 502, database connection module 503, query module 504, event log module 505 and security module 506.

The schedule module 501 is responsible for checking the predetermined rule at certain moments to determine whether to perform the query task, i.e. executing step 302 in FIG. 3. Conditional data collection module 502 is responsible for obtaining the SQL command required by the query, i.e. executing step 325 in FIG. 3. Database connection module 503 is responsible for connecting to the database, i.e. executing step 330 in FIG. 3. Query module 504 is responsible for issuing the SQL command to obtain the query result, i.e. executing step 340 in FIG. 3. Event log module 505 is responsible for recording abnormal status in the entire query task and normal status after the task is finished successfully, i.e. executing steps 360 and 370 in FIG. 3. Finally, security module 506 is responsible for ensuring the security of the data when the user 201 is about to obtain the variable of the server 204, i.e. executing steps 420, 430, and 440 in FIG. 4.

Within the scope of the present invention, the query program is not limited to the aforementioned modular structure; the emphasis is that as long as the query program can query the database at certain moments, update the variable of the server and provide the variable to the users, the advantage of the present invention can be achieved.

In overview, according to the present invention, it is to query the database at certain moments in asynchronous manner to update a variable of the server, then the server may provide the variable instantly to a user when the user queries so that the waiting time of users can be shortened. According to the present invention, since the repeated queries from many users are centralized and simplified into a time query of single program, thus the number of queries to the database is reduced, the burden of the database is eased and the usage of the server's memory is decreased.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method for asynchronous data query, comprising:
(a) executing the following two steps at certain moments according to a predetermined rule:
(a1) querying a database to obtain a query result;
(a2) updating a variable using the query result; and
(b) providing the variable to a user.

2. The asynchronous data query method as claimed in claim 1, wherein the predetermined rule is executing steps (a1) and (a2) according to a predetermined period.

3. The asynchronous data query method as claimed in claim 1, wherein step (a1) further includes:
connecting to the database; and
issuing an SQL command to the database to obtain the query result.

4. The asynchronous data query method as claimed in claim 1, wherein the query result is one of the following: single word, single number, array, data set, data table, data view and extensible markup language (XML).

5. The asynchronous data query method as claimed in claim 1, further comprising:
writing a normal status into an event log if steps (a1) and (a2) are finished successfully.

6. The asynchronous data query method as claimed in claim 1, further comprising:
writing an abnormal status into an event log if an exception occurs when executing step (a1) or (a2).

7. The asynchronous data query method as claimed in claim 1, further comprising:
refusing to provide the variable if the user's login ID has no access of reading the variable.

8. The asynchronous data query method as claimed in claim 7, further comprising:
encrypting at least one of the name and content of the variable.

9. The asynchronous data query method as claimed in claim 1, wherein the user is one of a web page and an application program.

10. A computer readable storage media storing a computer program for executing the asynchronous data query method as claimed in claim 1.

11. A system for asynchronous data query, comprising:
a database;
a server for providing a variable to a user; and
a query program for quering the database at certain moments according to a predetermined rule to obtain a query result, and updating the variable using the query result.

12. The asynchronous data query system as claimed in claim 11, wherein the predetermined rule is querying the database according to a predetermined period.

13. The asynchronous data query system as claimed in claim 11, wherein the query result is obtained from the database through a structure query language (SQL) command.

14. The asynchronous data query system as claimed in claim 11, wherein the query result is one of the following: single word, single number, array, data set, data table, data view and extensible markup language (XML).

15. The asynchronous data query system as claimed in claim 11, wherein the query program further includes the following function: writing a normal status into an event log if the variable is updated successfully.

16. The asynchronous data query system as claimed in claim 11, wherein the query program further includes the following function: writing an abnormal status into an event log if an exception occurs during the process of querying the database until updating the variable.

17. The asynchronous data query system as claimed in claim 11, wherein the the query program further includes the following function: refusing to provide the variable if the user's login ID has no right of reading the variable.

18. The asynchronous data query system as claimed in claim 17, wherein the query program further includes the following function: encrypting at least one of the name and content of the variable.

19. The asynchronous data query system as claimed in claim 11, wherein the user is one of a web page and an application program.
